(19) United States
(12) Patent Application Publication
(10) Pub. No.: US 2025/0091433 A1
(43) Pub. Date: Mar. 20, 2025

(54) ACCELERATOR PEDAL DEVICE FOR AN X-BY-WIRE SYSTEM OF A MOTOR VEHICLE

(71) Applicant: HELLA Gmbh & Co. KGaA, Lippstadt (DE)

(72) Inventors: Gilbert GRUNOW, Dortmund (DE); Claus VIETHEN, Erwitte (DE)

(73) Assignee: HELLA Gmbh & Co. KGaA, Lippstadt (DE)

(21) Appl. No.: 18/891,867

(22) Filed: Sep. 20, 2024

(30) Foreign Application Priority Data
Sep. 20, 2023 (DE) 10 2023 125 429.4

(51) Int. Cl. B60K 26/02

(52) U.S. Cl. CPC B60K 26/021; B60K 2026/025

(57) ABSTRACT

An accelerator pedal device for an x-by-wire system of a motor vehicle, having a housing, a pedal lever, which is rotatably mounted on the housing via a first bearing and via a second bearing which is axially spaced from the first bearing, and a load component which is designed in such a way that the pedal lever is radially loaded by the load component at the bearings, wherein both bearings are formed by a bearing surface of the pedal lever and a corresponding mating bearing surface of the housing, and wherein the bearing surface and the corresponding mating bearing surface of one of the bearings or both bearings are made conical on one side in the axial direction or one of the bearing is made conical on both sides.

This nonprovisional application claims priority under 35 U.S.C. § 119(a) to German Patent Application No. 10 2023 125 429.4, which was filed in Germany on Sep. 20, 2023, and which is herein incorporated by reference.

### BACKGROUND OF THE INVENTION

### Field of the Invention

The invention relates to an accelerator pedal device of a motor vehicle.

### Description of the Background Art

Conventional accelerator pedal devices are mechanically connected to a corresponding vehicle system. For example, a brake system of a motor vehicle is actuated hydraulically, wherein a piston is actuated by actuating a pedal lever of the brake pedal device in order to activate the wheel brakes. In so doing, the driver feels a pedal resistance during actuation. The causes of pedal resistance are various factors, such as the actual braking forces at the wheels, hydraulic oil pressure, mechanical resistance in the brake booster/master brake cylinder, and/or the force of a return spring that acts on the brake pedal. Thus, a driver is accustomed to this feeling of resistance when actuating the accelerator pedal.

In x-by-wire systems, in particular in brake-by-wire systems, the corresponding vehicle system is actuated via an electrical signal, which is usually triggered by an integrated control unit. There is no mechanical connection between the accelerator pedal device and the driving system. In order to nevertheless provide a pedal resistance for the driver and thus a familiar driving or actuation feel even with x-by-wire systems, this driving feel is imitated or simulated. Such an x-by-wire system and in particular the associated accelerator pedal device are disclosed, for example, in DE 10 2008 003 296 B4, which is incorporated herein by reference.

Such an imitation or simulation of the driving or actuation feel is effected in particular by a return movement acting against the actuation and an increased friction in the bearing of the pedal lever of the accelerator pedal device. The pedal lever is radially loaded in the bearing area by a return spring, whereby the bearing surfaces of the pedal lever are pressed against the mating bearing surfaces in sections, and thereby the frictional force acting between the bearing surfaces and the mating bearing surfaces is increased. It is problematic here that the friction that can be achieved in this way is relatively low and increasing the friction is not possible or is only possible with considerable effort.

### SUMMARY OF THE INVENTION

It is therefore an object of the invention to provide a pedal force device for a motor vehicle in which the best possible imitation or simulation of the driving or actuation feel can be provided in a simple and cost-effective manner.

The accelerator pedal device comprises a housing, which can be made of plastic, in particular by injection molding, and has a base body and a cover. The housing usually has a fastener to attach the accelerator pedal device to the motor vehicle or to the body shell of the motor vehicle.

The accelerator pedal device additionally can comprise a pedal lever, which is rotatably mounted on the housing and can therefore be pivoted between different positions. A pedal actuating plate is provided at one free end of the pedal lever, by which plate a driver can introduce force to the pedal lever and thereby pivot the pedal lever between the different positions. The rotatable mounting of the pedal lever on the housing takes place at an end opposite the pedal plate. For this purpose, the pedal lever is rotatably mounted on the housing via a first bearing and a second bearing which is axially spaced from the first bearing. In particular, the bearings are each arranged at one axial end of the pedal lever, wherein a bearing stub is provided at each of the axial ends.

Each bearing can be formed by a bearing surface provided on the pedal lever and a mating bearing surface provided on the housing, so that both bearings are designed as plain bearings. Alternatively, the first bearing can also be designed using an axially floating roller bearing and the second bearing can be designed as a plain bearing.

The accelerator pedal device further comprises a load component which is preloaded when the pedal lever is at rest, i.e., when the pedal lever is not actuated by the driver, and which acts on the pedal lever in such a way that the pedal lever is continuously loaded radially by the load component. As a result, the bearing surface is pressed continuously in sections against the respective mating bearing surface in the circumferential direction by the load component, and thereby the resulting frictional force between the bearing surface and the mating bearing surface is increased. The load component also serves as a restoring component.

The load component can be arranged in such a way that when the pedal lever is actuated by the driver, i.e., by the actuating force applied to the pedal lever, the load component is compressed by the actuating force, thereby causing a reaction force. This reaction force is dependent on a selected force-displacement characteristic of the load component and acts as a radial load in addition to the radial load in the bearings caused by the pretensioning of the load component.

In order to increase the friction between the surfaces of the pedal lever and the housing, which move relative to one another and slide against one another, the bearing surface of the pedal lever of the second bearing and the corresponding mating bearing surface of the housing of the second bearing are made conical in the circumferential direction, at least in sections, according to the invention, in such a way that the pedal lever is pressed against an axial bearing surface provided on the housing on the end face by the conical bearing surface and the conical mating bearing surface and the radial load due to the load component.

The conical design of the bearing surface and the mating bearing surface means that the load applied by the load component causes a normal force component on the conical bearing surface, which is made up of a vertical force component and an axial force component. Due to the contact, there is already friction or a frictional force between the bearing surface and the mating bearing surface. In addition, the axial force component causes additional friction on an axial bearing surface of the housing. The axial bearing surface is basically used for the axial bearing of the pedal lever, wherein the pedal lever is axially loaded by the axial force component and is thus pressed against an axial bearing surface. This increases the friction or frictional force between the axial bearing surface and a pedal lever surface that is in contact with the axial bearing surface.

This results in a resulting friction, which is the result of the friction between the bearing surface and the mating bearing surface and the friction between the axial bearing surface and the pedal lever surface that is in contact with the axial bearing surface.

This allows the friction between the pedal lever and the housing to be increased in a simple and cost-effective way and provides the best possible imitation or simulation of the driving or actuation feel.

Preferably, a rotation angle detection device can be arranged in the area of the axial bearing surface. X-by-wire systems are safety-critical systems, so that it is of essential importance for x-by-wire systems that the angle of rotation of the pedal lever is reliably detected. In this regard, even small deviations in the positioning of a transmitter element in relation to a sensor element can lead to distortions in the sensor signals. Because the rotation angle detection device is arranged on the axial bearing surface and the pedal lever is pressed against the axial bearing surface by the axial force component, any possible axial play between the pedal lever and the housing or the axial bearing surface is pushed out. In this way, a predefined distance between a transmitter element and a sensor element can be reliably maintained.

The transmitter element can be a permanent magnet, for example, which is arranged nonrotatably on the end face of the pedal lever, and the sensor element is a Hall sensor. Alternatively, the rotation angle detection device can be an inductive sensor or designed as a combination sensor formed of a magnetic sensor and an inductive sensor. With such a combined sensor, the angle of rotation is detected independently of each other by two sensor units, as a result of which the angle of rotation can be determined particularly reliably.

The accelerator pedal device can comprise a housing, a pedal lever, and a load component. The pedal lever is rotatably mounted on the housing via a first bearing and via a second bearing which is axially spaced from the first bearing. The load component is designed in such a way that the pedal lever is radially loaded by the load component in the area of the bearing.

According to the invention, both bearings can each be formed by a bearing surface of the pedal lever and a corresponding mating bearing surface of the housing, wherein either the bearing surface and the corresponding mating bearing surface of a single bearing are made conical on both sides in the axial direction or the bearing surface of the first bearing and the bearing surface of the second bearing are made conical opposite to one another and the mating bearing surface of the first bearing and the mating bearing surface of the second bearing are made conical opposite to one another. The conical design can be present over the entire circumference or only in sections. In both cases, two conical sliding surfaces are provided. In the design of a single bearing with conical bearing and mating bearing surfaces on both sides, the conical sliding surfaces of the bearing surface are pressed against the conical sliding surfaces of the mating bearing surface by the radial load from the load component. This causes a wedge effect, wherein the bearing surface, which forms the wedge, is inserted between the sliding surfaces of the mating bearing surface and pressed in. This causes a frictional force or friction between the two sliding surfaces of the bearing surface and the sliding surfaces of the mating bearing surface. The mode of operation of the design with conical bearing and mating bearing surfaces formed on both bearings is identical to the design with a single bearing, which has double-conical bearing and mating bearing surfaces. The decisive difference is that the surfaces which are conical to one another are divided between the two bearings.

In this simple and cost-effective way, the friction between the pedal lever and the housing can be increased and the best possible imitation or simulation of the driving or actuation feel can be provided.

A rotation angle detector can be arranged in the area of the second bearing. The pedal lever is clearly positioned axially due to the double-conical, i.e., conical on both sides in the axial direction, bearing surface and mating bearing surface such that any possible axial play between the pedal lever and the housing is pushed out and a predefined distance between a transmitter element and a sensor element of the rotation angle detection device can be reliably maintained thereby. This can provide a reliable rotation angle detection.

The load component can be, for example, a spring element which is arranged along the pedal lever between a pedal actuating plate and the pedal lever bearings and acts on the pedal lever. A restoring force acting against a foot actuation of the pedal lever and a radial load between the bearing surfaces and mating bearing surfaces can be provided by such a spring element in a simple and cost-effective manner. Only a single spring element is required for this.

The mating bearing surface and the bearing surface can have a conical bearing section and a cylindrical bearing section. The radial load on the pedal lever caused by the spring element acts exclusively in one direction, so that the bearing surface is only pressed against the mating bearing surface in sections, i.e., via the conical bearing section, preferably only over 180°. The cylindrical bearing section extends over the rest of the circumference, wherein the cylindrical bearing section serves to stabilize the bearing of the pedal lever.

The cylindrical bearing section of the mating bearing surface can be smaller in the circumferential direction than the cylindrical bearing section of the bearing surface. A relative movement between the sliding bearing surface and the bearing surface in the cylindrical bearing section can be enabled thereby. In particular, the cylindrical bearing section of the mating bearing surface is formed by a radial projection.

A bearing sleeve, which is fixedly connected to the pedal lever and forms the bearing surface, can be arranged on the first bearing and/or the second bearing. The bearing sleeve can be made of plastic. By selecting the material of the bearing sleeve, the friction between the bearing surface formed by the bearing sleeve and the mating bearing surface can be specifically influenced. In particular, the coefficient of friction can be adjusted by selecting the material of the bearing sleeve. The material of the pedal lever can be selected independently of the coefficient of friction and according to the required strength and rigidity.

The bearing sleeve can be made hollow in the conical area, wherein stiffening ribs are provided in the cavity. In this way, a constant wall thickness can be realized during the manufacturing process of the bearing sleeve, in particular by injection molding, whereby sink marks can be avoided. In addition, this can reduce the weight of the bearing sleeve.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an accelerator pedal device schematically and in a side view;

FIG. 2 shows an example of the accelerator pedal device from FIG. 1 in a sectional view;

FIG. 3 shows a bearing sleeve of the example of the accelerator pedal device from FIG. 1 in a perspective view;

FIG. 4 shows an example of the accelerator pedal device from FIG. 1 in a sectional view; and

FIG. 5 shows an example of the accelerator pedal device from FIG. 1 in a sectional view.

### DETAILED DESCRIPTION

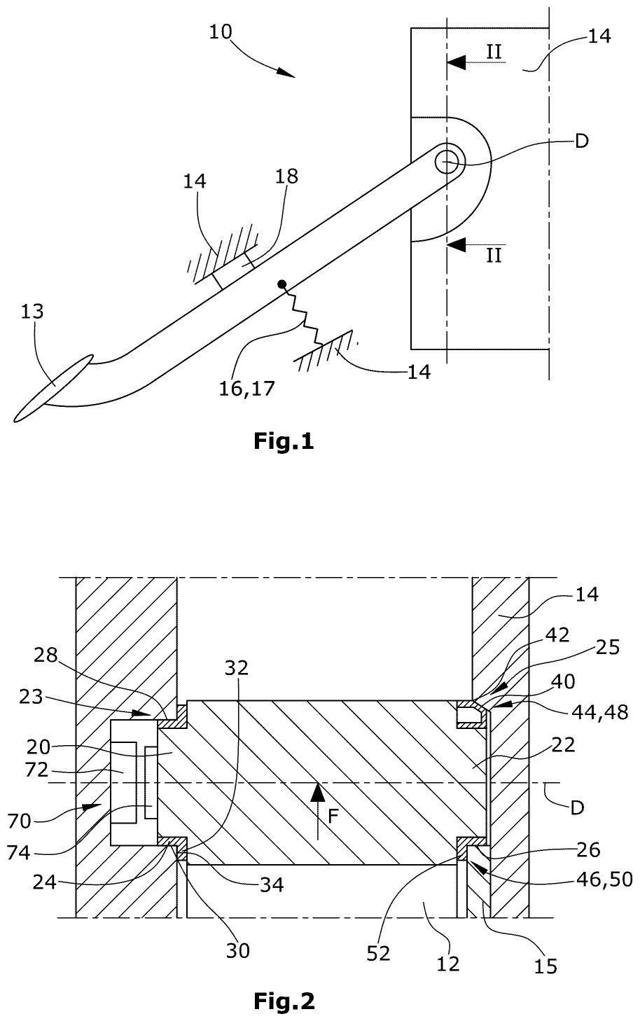

FIG. 1 shows an accelerator pedal device 10, which is in particular a component of an x-by-wire system of a motor vehicle. Accelerator pedal device 10 comprises a pedal lever 12 and a housing 14, wherein pedal lever 12 is rotatably mounted on housing 14 and can thus be adjusted between different rotation angle positions. Pedal lever 12 has a foot actuating plate 13, which is provided at a free end of pedal lever 12. In addition, accelerator pedal device 10 has a load component 16 and a stop 18. Load component 16 is designed as a spring element 17 and is connected at the end to pedal lever 12 and housing 14. Spring element 17 also serves as a return spring. In an unloaded state, pedal lever 12 rests against stop 18, wherein spring element 17 is designed in such a way that it is pretensioned and thereby presses pedal lever 12 against stop 18 and against housing 14 in the bearing area of pedal lever 12.

The rotatable mounting of pedal lever 12 on housing 14 is shown in FIG. 2. Pedal lever 12 has a bearing stub 20, 22 at both axial ends in order to provide a first bearing 23 and a second bearing 25. A bearing sleeve 24, 26 each is arranged on bearing stubs 20, 22, which sleeve is arranged nonrotatably with the respective bearing stub 20, 22 and thus rotates together with pedal lever 12 when pedal lever 12 is adjusted.

A first bearing sleeve 24 has a cylindrical bearing surface 28 of first bearing 23, which bears against a corresponding cylindrical mating bearing surface 30 of housing 14. First bearing sleeve 24 also has a radial projection 32, which bears axially against pedal lever 12 with an axial side facing away from bearing surface 28 and bears against an axial bearing surface 34 of housing 14 with an axial side facing the bearing surface.

A second bearing sleeve 26 has a bearing surface 40, which bears against a corresponding mating bearing surface 42 of housing 14. Bearing surface 40 and mating bearing surface 42 each have a conical bearing section 44, 48 and a cylindrical bearing section 46, 50.

As a result, bearing surface 40 bears against conical bearing section 48 of mating bearing surface 42 via conical bearing section 44 in such a way that the normal force present comprises an axial force component and a radial force component. Bearing surface 40 is in permanent contact with mating bearing surface 42 in conical bearing section 44, 48 due to the load of pedal lever 12 and is pressed against mating bearing surface 42. When pedal lever 12 is actuated via pedal actuating plate 13, bearing surface 40 in conical bearing section 44, 48 is pressed against mating bearing surface 42. In addition, bearing surface 40 in conical bearing section 44, 48 is pressed against mating bearing surface 42 by the pretensioning of spring element 17 even when pedal lever 12 is not actuated.

In cylindrical bearing section 46, 50, bearing surface 40 bears exclusively radially against mating bearing surface 42, wherein cylindrical bearing section 50 of mating bearing surface 42 is formed by a separate element 15 fixed to housing 14 and is made substantially smaller in the circumferential direction than cylindrical bearing section 46 of bearing surface 40 in order to permit an adjusting movement of pedal lever 12. In the area of cylindrical bearing section 46, a radial projection 52 is provided on second bearing sleeve 26, which bears axially against pedal lever 12 with an axial side facing away from bearing surface 40 and bears axially against element 15 with an axial side facing bearing surface 40.

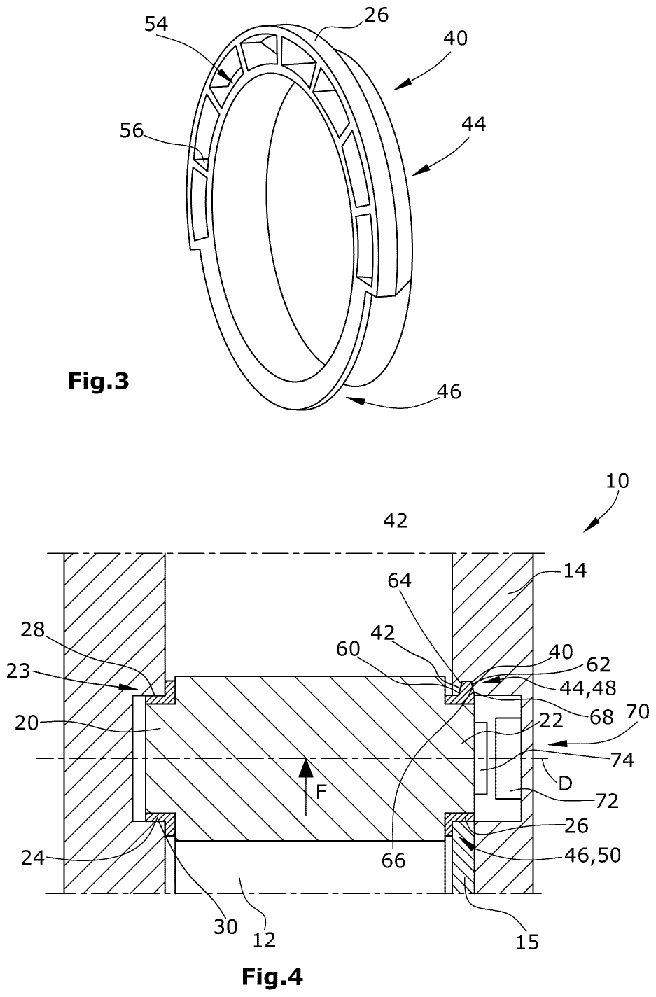

Second bearing sleeve 26 is also shown in FIG. 3. Second bearing sleeve 26 is made hollow in the area of conical bearing section 44, wherein multiple stiffening ribs 56 are arranged in cavity 54. As a result, sink marks can be avoided in the manufacturing process. In addition, the weight of second bearing sleeve 26 can be reduced.

Conventional accelerator pedal devices are mechanically connected to a corresponding vehicle system. For example, a brake system of a motor vehicle is actuated hydraulically, wherein a piston is actuated by actuating a pedal lever of the brake pedal device in order to activate the wheel brakes. In so doing, the driver feels a pedal resistance during actuation. In x-by-wire systems, in particular in steer-by-wire or brake-by-wire systems, the corresponding vehicle system is actuated via an electrical signal, which is usually triggered by a built-in control unit. There is no mechanical connection between the accelerator pedal device and the driving system.

In order to provide pedal resistance for the driver in an x-by-wire system and thus a familiar driving or actuation feel in x-by-wire systems, this driving feel is imitated or simulated. The imitation or simulation of the driving or actuation feel is effected by means of a return movement acting against the actuation and an increased friction in bearings 23, 25 of pedal lever 12. The return movement is achieved by spring element 17. The increased friction is achieved in that pedal lever 12 is radially loaded in the bearing area by spring element 17, and bearing surface 28, 40 is pressed against the corresponding mating bearing surface 30, 42 thereby. This causes a frictional force which acts between bearing surfaces 28, 40 and mating bearing surfaces 30, 42 and acts against the adjustment movement of pedal lever 12.

According to the invention, conical bearing sections 44, 48, as previously explained, cause an axial force component by which pedal lever 12 is loaded in the axial direction. The axial load on pedal lever 12 causes first bearing sleeve 24 with radial projection 32 to be pressed axially against axial bearing surface 34, thereby creating an additional frictional force.

This results in a resulting friction, which is the result of the friction between bearing surfaces 28, 40 and mating bearing surface 30, 42 and the friction between axial bearing surface 34 and the surface of pedal lever 12 that is in contact with axial bearing surface 34. In this way, the friction between pedal lever 12 and housing 14 can be increased in a simple and cost-effective manner and the best possible imitation or simulation of the driving or actuation feel can be provided.

The accelerator pedal device also has a rotation angle detection device 70, which is arranged in the area of first bearing 23. Rotation angle detection device 70 comprises a magnetic field sensor 72 and a permanent magnet 74, wherein permanent magnet 74 is arranged on the end face of pedal lever 12. Magnetic field sensor 72 detects the magnetic field of permanent magnet 74, from which the angle of rotation of the pedal lever 12 can be determined, wherein a predefined distance between magnetic field sensor 72 and permanent magnet 74 must be maintained in the detection of the magnetic field of permanent magnet 74. Because pedal lever 12 is pressed against axial bearing surface 34 by the axial force component, axial play can be prevented and the distance between permanent magnet 74 and magnetic field sensor 72 can be reliably maintained.

FIG. 4 shows a second embodiment of accelerator pedal device 10. The decisive difference from the first embodiment in FIGS. 2 and 3 is the design of second bearing 25 and second bearing sleeve 26. Bearing surface 40 and mating bearing surface 42 are made conical here on both sides in such a way that bearing surface 40 has two mutually opposite conical sliding surfaces 60, 62 and the corresponding mating bearing surface 42 has two mutually opposite conical sliding surfaces 64, 66. In this case, second bearing sleeve 26 forms a wedge-shaped radial projection 68, wherein a sliding surface 60, 62 each is arranged on both axial sides of radial projection 60. As in the first embodiment according to FIG. 2, bearing surface 40 and mating bearing surface 42 have a conical bearing section 44, 48 and a cylindrical bearing section 46, 50, wherein second bearing sleeve 26 is designed accordingly.

In operation, radial projection 68 is pressed by the radial force caused by spring element 17 into an opening 67 of housing 14, which is axially limited by the two conical sliding surfaces 64, 66, in such a way that a frictional force is caused between the two sliding surfaces 60, 62 of bearing surface 40 and sliding surfaces 64, 66 of mating bearing surface 42. An increase of the friction surface is achieved thereby and thus the friction between pedal lever 12 and housing 14 is increased.

In the second embodiment, rotation angle detection device 70 is arranged in the area of second bearing 25, wherein rotation angle detection device 70 also has a magnetic field sensor 72 and a permanent magnet 74, wherein permanent magnet 74 is arranged on the end face of pedal lever 12. Due to the bilateral conical design of bearing surface 40 and mating bearing surface 42, pedal lever 12 is arranged axially in a predefined position, whereby axial play can be prevented and the distance between permanent magnet 74 and magnetic field sensor 72 can be reliably maintained.

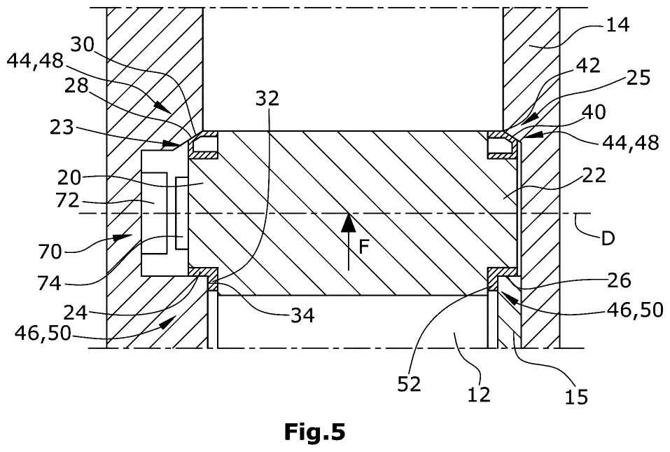

FIG. 5 shows a third embodiment that comes very close to the second embodiment, wherein the mode of operation corresponds to the mode of operation of the second embodiment. In contrast to the second embodiment shown in FIG. 4, a conical bearing surface 28, 40 is provided in each case on both bearings 23, 25, i.e., on both bearing sleeves 24, 26, wherein bearing surfaces 28, 40 are made conical opposite to one another. Mating bearing surfaces 30, 42 are also made conical opposite to one another.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An accelerator pedal device for an x-by-wire system of a motor vehicle, the device comprising:
a housing;
a pedal lever rotatably mounted on the housing via a first bearing and via a second bearing that is axially spaced from the first bearing; and
a load component designed such that the pedal lever is radially loaded by the load component at the first and second bearings,
wherein the second bearing is formed by a bearing surface of the pedal lever and a corresponding mating bearing surface of the housing,
wherein the bearing surface and the corresponding mating bearing surface are formed conical in a circumferential direction, at least in sections, such that the pedal lever is pressed axially against an axial bearing surface provided on the housing by a conical bearing surface and a conical mating bearing surface and the radial load due to the load component.

2. The accelerator pedal device according to claim 1, wherein a rotation angle detector is arranged in an area of the axial bearing surface.

3. An accelerator pedal device for an x-by-wire system of a motor vehicle, the device comprising:
a housing;
a pedal lever rotatably mounted on the housing via a first bearing and via a second bearing that is axially spaced from the first bearing; and
a load component designed such that the pedal lever is radially loaded by the load component at the bearings,
wherein the first and second the bearings are each formed by a bearing surface of the pedal lever and a corresponding mating bearing surface of the housing,
wherein the bearing surface of the second bearing and the corresponding mating bearing surface are formed conical on both sides in the axial direction, or the bearing surface of the first bearing and the bearing surface of the second bearing are formed conical opposite to one another and the mating bearing surface of the first bearing and the mating bearing surface of the second bearing are made conical opposite to one another.

4. The accelerator pedal device according to claim 3, wherein a rotation angle detector is arranged in an area of the second bearing.

5. The accelerator pedal device according to claim 2, wherein the rotation angle detector has an inductive sensor and/or a magnetic sensor.

6. The accelerator pedal device according to claim 1, wherein the load component is a spring element which is arranged along the pedal lever between a pedal actuating plate and the first and second bearings of the pedal lever and acts on the pedal lever.

7. The accelerator pedal device according to claim 1, wherein the mating bearing surface and/or the bearing surface have a conical bearing section and a cylindrical bearing section.

8. The accelerator pedal device according to claim 7, wherein the conical bearing section extends by 180°.

9. The accelerator pedal device according to claim 7, wherein the cylindrical bearing section of the mating bearing surface is smaller in a circumferential direction than the cylindrical bearing section of the bearing surface.

10. The accelerator pedal device according to claim 1, wherein a bearing sleeve, which is fixedly connected to the pedal lever and forms the bearing surface, is arranged on the first bearing and/or the second bearing.

11. The accelerator pedal device according to claim 10, wherein the bearing sleeve is made hollow in the area of the conical region, and wherein stiffening ribs are provided in the cavity.
